(19) United States
(12) Patent Application Publication
(10) Pub. No.: US 2015/0099249 A1
(43) Pub. Date: Apr. 9, 2015

(54) EDUCATIONAL GAMING PLATFORM

(71) Applicant: IMAGINARY NUMBER INC., Hercules, CA (US)

(72) Inventors: Christopher Charles Van Norman, San Francisco, CA (US); Vivian Yu Hui Tan, Santa Clara, CA (US); Morgan Quirk, San Francisco, CA (US)

(21) Appl. No.: 14/506,501

(22) Filed: Oct. 3, 2014

Related U.S. Application Data
(60) Provisional application No. 61/886,297, filed on Oct. 3, 2013.

(51) Int. Cl. G09B 23/02; G09B 5/02

(52) U.S. Cl. CPC G09B 23/02; G09B 5/02
USPC 434/201; 434/362

(57) ABSTRACT

Described are systems and methods for providing an educational gaming platform. The educational gaming platform can include games and puzzles that users can solve. The educational gaming platform can also include an editor that permits users to modify the games and puzzles as well as create new games and puzzles.

### RELATED APPLICATION

This application claims the benefit of U.S. Provisional Application No. 61/886,297, filed Oct. 3, 2013, the entire contents of which are incorporated herein by reference.

### TECHNICAL FIELD

Embodiments of the present disclosure relate to the field of computing systems, and more specifically, to an educational gaming platform.

### BACKGROUND

As technology progresses, new technology can be used to advance society. For example, computers can be used for educational purposes and to teach various concepts.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 illustrates an example system architecture in which embodiments of the present disclosure can be implemented.

FIG. 2 illustrates a game world and component module hierarchy, in accordance with embodiments.

FIG. 3 illustrates symbolic representations of a static number object and a dynamic number object, in accordance with embodiments.

FIG. 4 illustrates a collision between two positive number objects, in accordance with embodiments.

FIG. 5 illustrates a collision action between a positive number object and a negative number object, in accordance with embodiments.

FIG. 6 illustrates one embodiment of a collision action between two number objects whose values have a sum equal to zero, in accordance with embodiments.

FIG. 7 is a diagram of a number hoop, in accordance with embodiments.

FIG. 8 is a diagrammatic representation of a number object passing through a number hoop from one direction, in accordance with embodiments.

FIG. 9 illustrates a diagrammatic representation of a number object passing through a number hoop from a second direction, in accordance with embodiments.

FIG. 10 illustrates a symbolic representation of a player avatar, in accordance with embodiments.

FIG. 11A is a diagrammatic representation of a player avatar picking up and holding a gadget object, in accordance with embodiments.

FIG. 11B is a diagrammatic representation of a player avatar picking up and holding a number object, with a “throw” action equipped as a gadget, in accordance with embodiments.

FIG. 12 illustrates a symbolic representation of number ammunition object, in accordance with embodiments.

FIG. 13 illustrates a diagrammatic representation of a player avatar picking up a number object as ammunition for a gadget object, in accordance with embodiments.

FIG. 14 illustrates an impact of a gadget object's area effect operation on multiple number objects at a same time, in accordance with embodiments.

FIG. 15 illustrates a gadget that breaks a number object into factors, in accordance with embodiments.

FIG. 16 illustrates a gadget that breaks a number object into fractions, in accordance with embodiments.

FIG. 17A illustrates a symbolic representation of an animated number enemy comprising a single number object, in accordance with embodiments.

FIG. 17B illustrates a symbolic representation of an animated number enemy comprising multiple number objects, in accordance with embodiments.

FIG. 18 illustrates an example interaction between a player avatar and an animated number enemy, in accordance with embodiments.

FIG. 19 illustrates a symbolic representation of a generic machine, in accordance with embodiments.

FIG. 20 illustrates a builder machine that creates structures from number objects, in accordance with embodiments.

FIG. 21 illustrates a conversion machine that changes a form of a number object, in accordance with embodiments.

FIG. 22 illustrates a number generation machine that outputs one or more number objects, in accordance with embodiments.

FIG. 23 illustrates a modification applied to a number generation machine to change a number object output, in accordance with embodiments.

FIG. 24 illustrates a modification applied to a number hoop, in accordance with embodiments.

FIG. 25 illustrates a diagrammatic representation of a credit gem, in accordance with embodiments.

FIG. 26 illustrates a gem zone in which enemies may be transformed into one or more credit gems, in accordance with embodiments.

FIG. 27 illustrates a timed gem zone that runs on a timer in accordance with embodiments.

FIG. 28 illustrates a diagrammatic representation of how a credit collection process, in accordance with embodiments.

FIG. 29 illustrates a credit factory that may transform number objects into credit gems according to a growth formula, in accordance with embodiments.

FIGS. 30A-B illustrate growth mechanic structures that may produce new number objects, in accordance with embodiments.

FIG. 31 is a flow diagram illustrating a method for providing an educational game platform, in accordance with some embodiments.

FIG. 32 illustrates block diagram of an example computing device that may perform one or more of the operations described herein.

FIG. 33 illustrates example system architecture in which implementations can operate, in accordance with embodiments.

### DETAILED DESCRIPTION

Implementations of the present disclosure provide a video game platform that may be both education and fun to play. The video game platform may be used to teach any subject, such as mathematics. For example, the video game platform enables users to learn math and/or teach math through gameplay and/or game content creation. Users can be players and/or builders. As players, users can complete tasks, solve puzzles and advance to different levels. As builders, users can create tasks, puzzles and levels for other users to play. The video game can be two dimensional (2D), three dimensional (3D) or four dimensional (4D). Examples of a fourth dimension include sensory elements, such as smell, touch, hear, etc. The video game platform allows for users to generate their own math challenges and puzzles to teach all fields of math in a variety of ways that tie into a single video game world.

Although the description herein refers to mathematics as an example type of educational subject, implementations of the disclosure may apply to other types of educational subjects and topics.

In the following description, numerous details are set forth. It will be apparent, however, to one of ordinary skill in the art having the benefit of this disclosure, that embodiments of the present invention may be practiced without these specific details. In some instances, well-known structures and devices are shown in diagram or symbolic form, rather than in detail, in order to avoid obscuring the embodiments of the present invention.

Platform Architecture and Creation Cycle

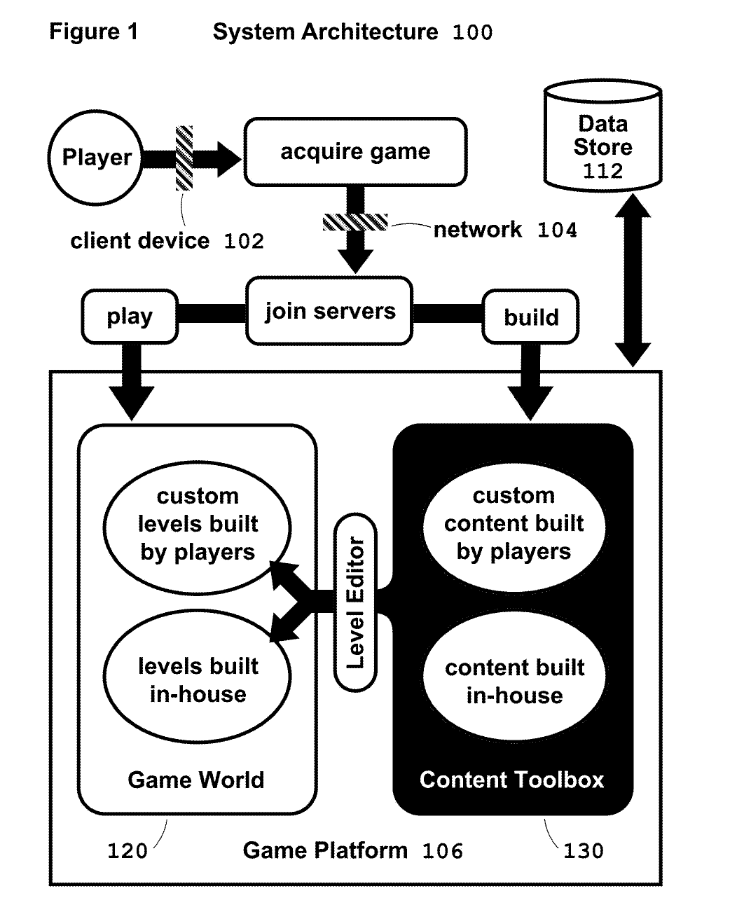

FIG. 1 illustrates an example system architecture 100 in which embodiments of the present disclosure can be implemented. The system architecture 100 includes one or more client devices 102, a network 104, a data store 112, and a game platform 106. In one implementation, the network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In one implementation, the data store 112 may be a memory (e.g., random access memory), a cache, a drive (e.g., a hard drive), a flash drive, a database system, or another type of component or device capable of storing data. The data store 112 may also include multiple storage components (e.g., multiple drives or multiple databases) that may also span multiple computing devices (e.g., multiple server computers).

The client device 102 may include computing devices such as personal computers (PCs), laptops, mobile phones, smart phones, tablet computers, netbook computers etc. In some implementations, the client device 102 may also be referred to as “user device” or “user mobile device.” Each client device 102 may include a video game application (not shown) that interacts with the game platform 106, or functions independently of the game platform 106, as described herein.

The game platform 106 may be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a video game. For example, the game platform 106 may allow a user to access, download, play, modify or create parts of a video game. The game platform 106 may also include a website (e.g., a webpage) that may be used to provide a user with “cloud-based” access to the video game.

The game platform 106 can host two types of content: playable levels (such as in a game world 110) and creative content for building or modifying levels (in a toolbox 120 or level builder). As used herein, the term “creative content” refers to modules, level creation or modification tools, or any content used for creating levels and not the levels themselves.

The game platform 106 may include game world 120 that includes levels created by an owner of the game platform 106 (or any entity associated with the game platform 106) and/or levels created by a player community. The game platform 106 may include a content tool box 130 that includes creative content developed by the owner of the game platform 106 and/or creative content provided by the player community. Such creative content may include component modules, puzzle modules, mods, skins, or other functional and/or decorative elements that can be used in building and designing game levels. The owner of the game platform 106 and the player community may have access to the contents in the content tool box 130 for the purpose of building game levels to be added to the game world 106.

Once a client device 102 has connected to a server associated with the game platform 106, a user of the client device 102 may opt to play the game levels or to become a builder by contributing additional levels and creative content. Using the level editor, a builder can build new levels by assembling pre-existing modules or other content or by modifying existing levels. These custom levels may be added to the game world 120. More advanced builders may also create new modules or other content that may be available to other users of the game platform 106. These editable modules and content can be part of the content tool box 130.

Module Hierarchy and Interaction

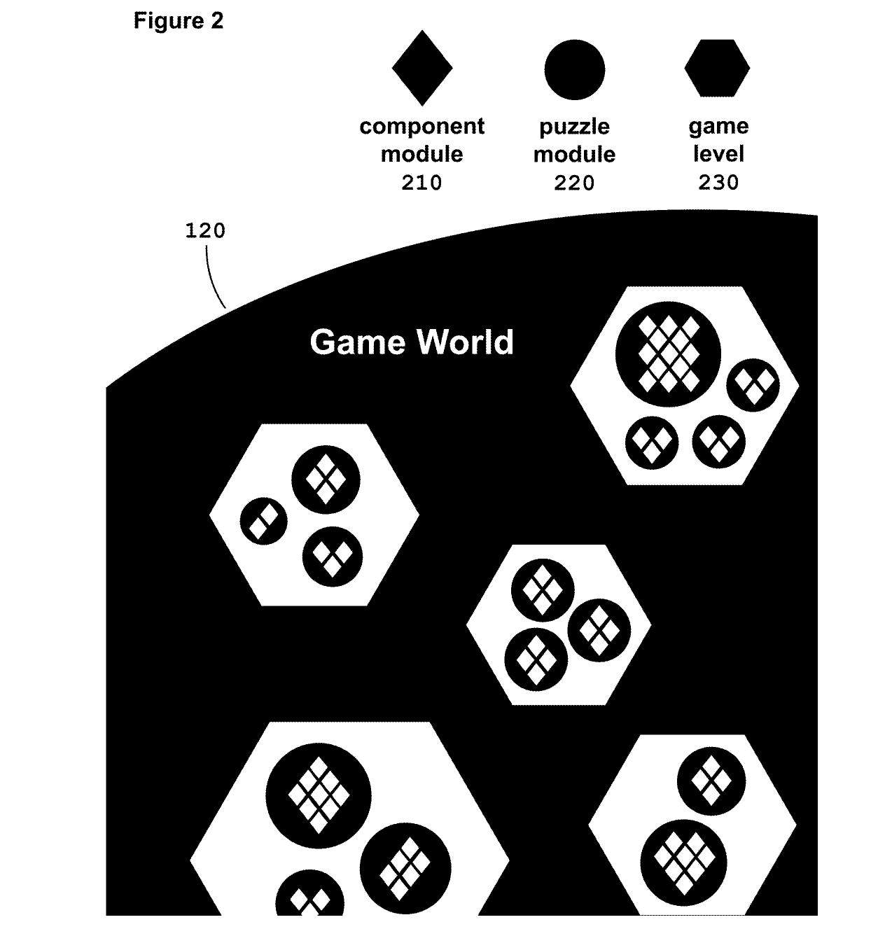

The game world 120 may include a hierarchy of modules and levels. FIG. 2 illustrates a game world 120 and module hierarchy, in accordance with embodiments.

Described are three types of modules: component modules 210, puzzle modules 220, and decorative modules 230. Component modules 210 and puzzle modules 220 can define various mechanisms of gameplay within a game level 230 of the game world 120 and may operate based on a set of rules. Decorative modules (not shown) may define visual and/or audio aesthetics of the game world 120.

Component Module

A basic functional building block of the game platform 106 is a component module 210. Component modules 210 may interact and/or combine with one another to form a puzzle module 220. Similarly, puzzle modules 220 may be arranged in various combinations to form a game level 230. A collection of game levels 230 (of varying difficulty) may form the game world 120. A complexity of the module combinations can influence the difficulty of each game level 230. For example, a level with a high number of modules can represent a more difficult game level 230. To defeat a game level 230, a player may solve puzzles provided within the game world 120 by the game platform 106 by through their understanding of mathematical concepts and by inputting mathematical operations. The game platform 106 may translate the user input into data and may use the data to advance the user through levels. For example, when the game platform 106 receives user input that matches an expected value for a particular task, the game platform 106 can mark the task as complete. The game platform 106 can then present further tasks to the user. In some embodiments, the game platform 106 provides the player with increasingly difficult levels.

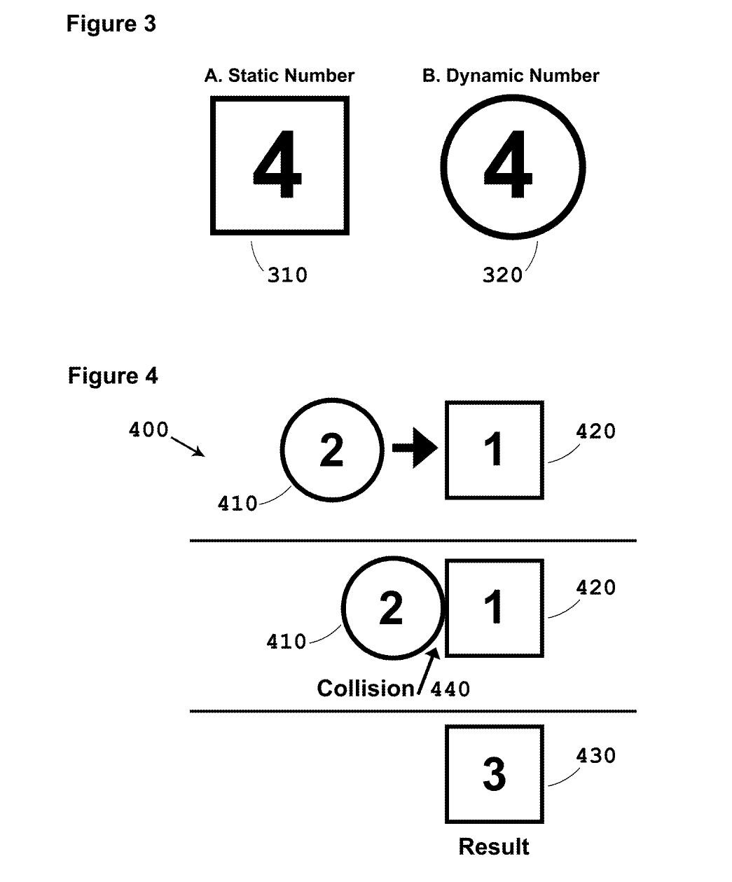

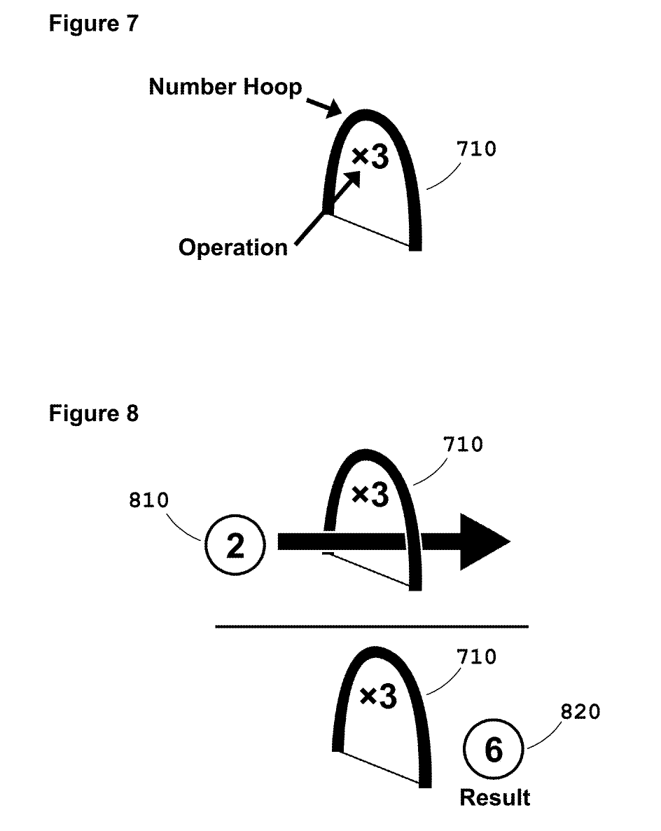

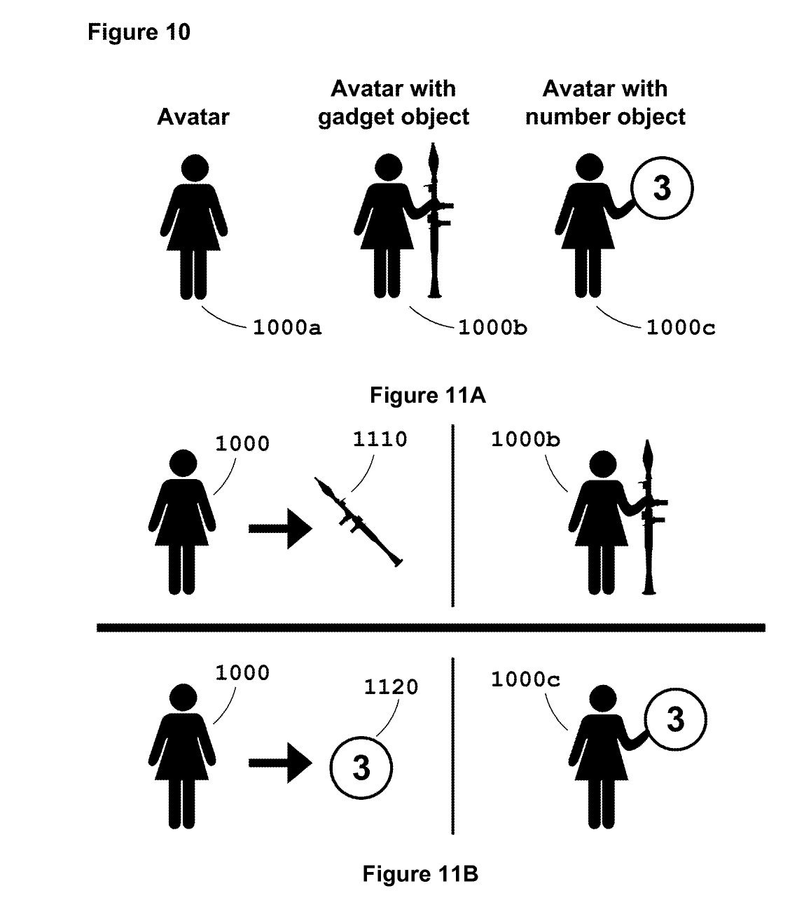

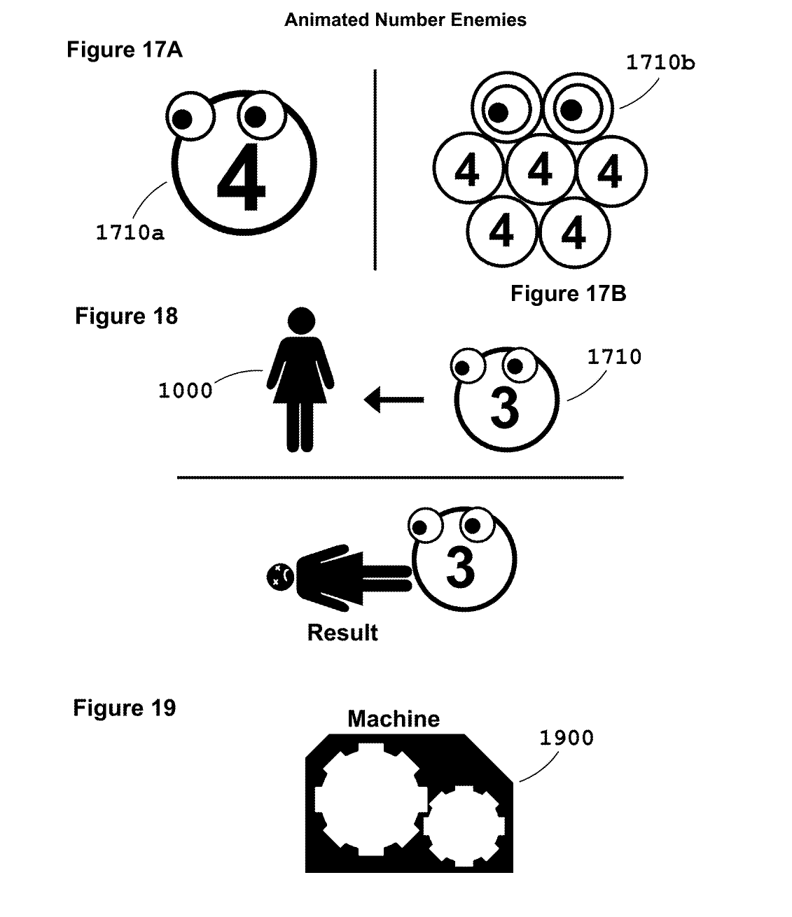

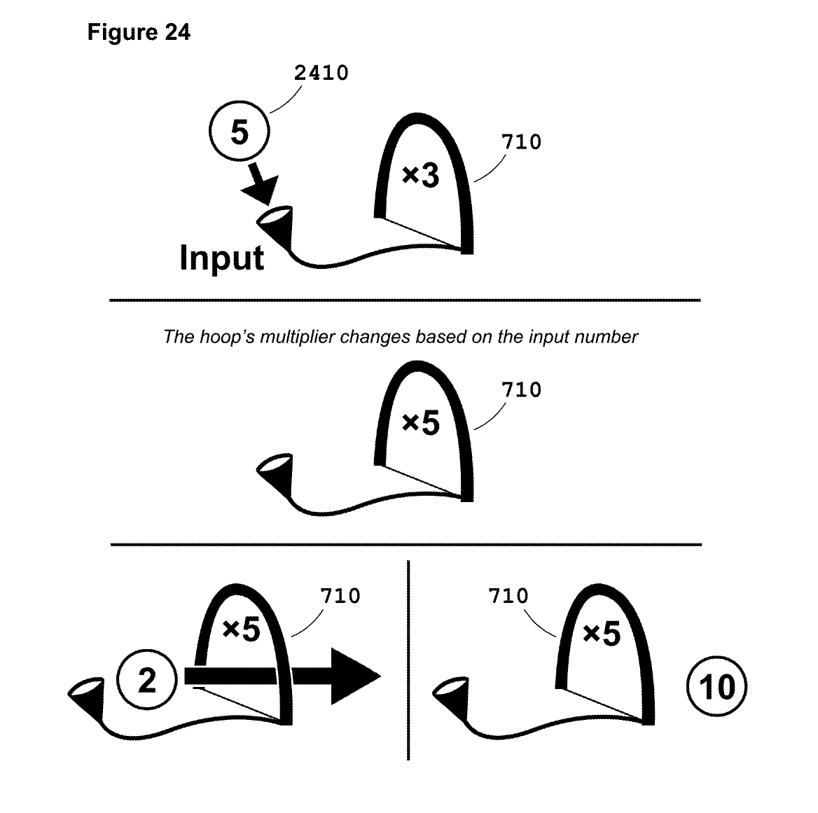

Examples of component modules 210 are myriad and can include number objects (such as those described in conjunction with FIGS. 3-6), hoops or doorways that represent mathematical operations (such as those described in conjunction with FIGS. 7-9), gadgets that may contain number ammunition and perform different mathematical operations with varying impact ranges and efficacy (such as those described in conjunction with FIGS. 10-16), script-controlled enemies (e.g., artificial intelligence (AI)) that can attack the player or each other (such as those described in conjunction with FIGS. 17-18), machines that create or modify other modules (such as those described in conjunction with FIGS. 19-21), machine sub-parts that modify machines (such as those described in conjunction with FIGS. 23-24), algorithm-based devices that can automatically generate or destroy number objects in specific patterns or according to specific rules (not shown), or any other functions or operations that can be implemented in the game through script-controlled entities.

Puzzle Modules

Puzzle modules 220 are combinations of two or more component modules 210. The term “puzzle” may refer to closed-form puzzle modules 220 where the outcome may be limited or pre-defined. Alternatively, a puzzle module 220 may be an open-ended puzzle where the goals and accomplishment milestones are more loosely defined.

Closed-form puzzle modules 220 may take various forms, such as sequences of hoops or doorways that the player must pass through in specific orders, obstacles that the player must destroy, arrangements of machines that the player must activate/or deactivate, battles with script-controlled enemies that the player must overcome, or any other combination of component modules that can be solved through the game platform's assessment of the user's understanding of mathematical concepts. As the game platform's assessment of the user's understanding become more complex, the puzzles can similarly increase in complexity to keep the user engaged and to facilitate continued learning. For example, as a user continues to successfully complete puzzles, the game platform may determine that the user's understanding is increasing.

Decorative Modules

Decorative modules, when attached to or associated with other modules or objects, may be used to signal or symbolize certain types of functionality. For example, gadget modules of certain colors may be associated with particular types of special capabilities; or, machine modules may emit certain sound effects to indicate that they have been triggered. Decorative modules may include skyboxes (e.g., backdrops), textures or skins that define the colors and/or patterns of avatars/characters, objects, or interfaces; models that define the shapes of avatars/characters or objects; special effects or lighting effects that affect the appearance of the game world; ambient sounds, music, sound clips, sound effects or other audio; or any other “decorative” element that may be used to change the look, feel, and sound of the game or the characters and objects within it without changing their functionality.

Examples of Module Interaction

Open-ended puzzle modules may have less restrictive goals because they are constructed by a combination of component modules that may enable different mechanics or behaviors, including sandbox-style mechanics (which allows players to experiment with mathematical combinations), multi-player battle mechanics, racing or competition mechanics, or any other mechanics/behaviors governed by mathematical principles. For open-ended puzzle modules, the player uses her knowledge and understanding of mathematical operations to interact with the open-ended puzzle modules. With open-ended puzzle modules, however, multiple different outcomes are possible; the user may reach one of many different possible outcomes to complete an open-ended puzzle.

The following example is one embodiment of how component modules 210 may interact to form a closed-form puzzle module 240. In the example. a player has access to the following: dynamic number objects (as further described in conjunction with FIG. 3) marked with the positive number 2, static number objects (as further described in conjunction with FIG. 3) marked with negative 6 that form an obstacle wall, and a number hoop (as further described in conjunction with FIG. 8) that multiplies by 3 when entered from one side and divides by three when entered from the other side. The player's objective is to create a hole in the obstacle wall in order to advance in the level. The hole can be created using mathematical operations, such as by adding a positive number to a negative number to equal zero. In this example, the correct sequence for solving this puzzle is for the player to pick up the positive number 2 object, pass through the hoop from the direction that multiplies by 3, and use the resulting positive 6 number object to zero-out part of the obstacle wall (as further described in conjunction with FIG. 6). The resulting hole may be sufficient for gaming platform to allow the user to advance to the next puzzle or level. In other embodiments, the user is to create a hole sufficient in size to allow a particular object to pass through the hole, or must zero-out the entire obstacle wall.

The following example is one embodiment of how the component modules 210 of the game platform 106 may interact to form an open-ended puzzle module. As in the previous example, the player solves the open-ended puzzle module by using dynamic number objects and number hoops to break down number obstacle walls. However, in this example, the player has access to a wider range of dynamic numbers, a wider range of number hoop operations, and a series of walls to break through. The player's objective is to beat the clock (or to beat another player or group of players) by breaking down the number walls as quickly as possible, using any combination of numbers and operations.

Alphanumeric Objects Overview

Alphanumeric objects are building blocks of the game world 120. Alphanumeric objects are interactive game objects with specific properties. An alphanumeric object may represent any number, letter, character, or any other symbol. For clarity in explanation, the alphanumeric objects are described herein in terms of one or more number objects.

FIGS. 3-6 illustrate schematic diagrams of example interactions between “static” and “dynamic” number objects. Static number objects and dynamic number objects may follow specific behaviors that determines how each type of objects interacts with each other, with the player, or within the game world 120.

FIG. 3 illustrates symbolic representations of a static number object 210 and a dynamic number object 320, in accordance with embodiments.

Static number objects can have the following properties:

They contain number information; such as a value represented as a positive or negative integer, fraction, percent, etc.

They can represent a mathematical operation, such as plus, minus, multiple, divide, exponent, square root, root, log, etc.

Their value is displayed as integer text on the object, which is visible to the player

They cannot move or be moved.

They can be moved if the player is equipped with a special gadget and the player uses the special gadget to move the static number object.

They cannot be picked up to be used as ammunition.

They can block the player's path.

They can be walked on (e.g. as stairs or pathways)

They will combine with dynamic number objects when the two collide (the value of the static number will be changed, and the dynamic number will disappear)

They can be affected by gadgets (the value of the static number will be changed)

They can disappear if their value is set to zero. Number objects equal to zero cannot exist in the game. (except in limited circumstances, where zero is part of the learning objective (e.g. binary numbers))

They can change in appearance to the user if their value matches a predefined value. For example, they can disappear if their value is set or changed to zero or they can change color or shape of their value is set or changed to the predefined value

Dynamic number objects may share some or all of the same properties as static number objects, except:

They can move or be moved.

They cannot be walked on.

They can be picked up as ammunition.

They combine with any number object they touch/collide

Moving Number Objects

Dynamic number objects can move or be moved in the following ways:

They can move on their own according to physics in the game world (e.g. falling or rolling downwards due to gravity, wind, etc.)

They can be picked up and thrown by the player (as further described in conjunction with in FIG. 11B).

They can be loaded into a gadget as ammunition rounds and propelled (as further described in conjunction with in FIG. 13).

They can be picked up by artificial intelligence (AI), such as enemies, or other in-game AI players

Number Object Collision Interactions

Collision between number objects is an action in the game world. When two number objects collide or touch, they can combine according to a set of rules. An example set of rules is as follows:

When two dynamic numbers objects collide with each other, OR when a static number object and a dynamic number object collide, the two objects can combine into one.

The collision operation can be addition by default.

The value of the new object can be the sum of the value of the two number objects that combined, unless one of the number objects is propelled, as ammunition, through a gadget that performs a different operation (e.g. multiplication), which would instead return the corresponding result (e.g. the product of the two number objects).

If the collision is between a static number object and a dynamic number object, the static object can absorb the dynamic object and the resulting object will take the form of the static object.

When the resulting sum of the collision combination equals zero, the resulting number object can be destroyed and disappears from the game.

If the collision is between two alphabetic objects, the resulting object can be a concatenation of the two alphabetic objects. For example, when a first alphabetic object is a letter “B” and a second alphabetic object is an “E,” the resulting object can be “BE.”

FIG. 4 illustrates a collision flow 400 between two positive number objects 410, 420. In the depicted embodiment, a positive dynamic number object 410 combines with a positive static number object 420, causing a collision 440 and resulting in a static number object 430 with a new value that is the sum of the two number objects.

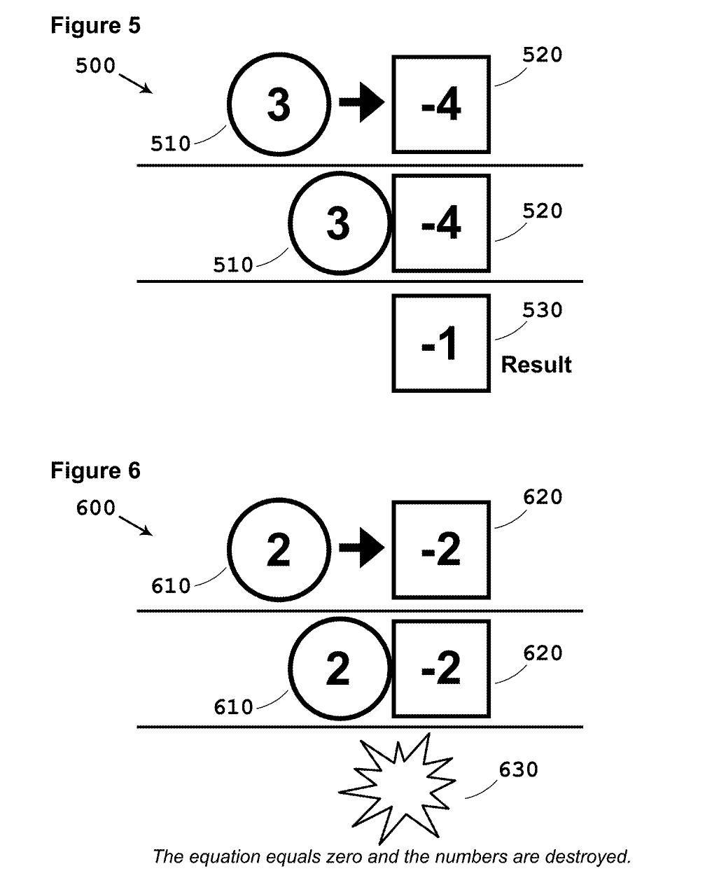

FIG. 5 illustrates a collision flow 500 between a positive number object 510 and a negative number object 520. In the depicted embodiment, the two number objects combine and result in a static number object 530 whose value is equal to the sum of the positive and the negative values, e.g. −4+3=−1.

FIG. 6 illustrates a collision flow 600 between two number objects, 610, 620 whose sum is equal to zero. In the depicted embodiment, the resulting object 630 is immediately destroyed.

Number Hoops

FIGS. 7-9 illustrate example operations of a number hoop 710 in accordance with some implementations. A number hoop 710 can have at least the following properties:
Number hoops can be gateways that objects in the game can pass through.
Number hoops can have a mathematical operation associated with them, which can be displayed inside the hoop in plain text format, e.g. “×3” or multiplied by 3.
The mathematical operation associated with the number hoop can be arbitrary, and can be *3, +4, *7+4, *5̂4, or any other combination of operations.
Number hoops can stand alone or can be attached to a structure in the game (e.g. as the doorway of a building).
Number hoops can be double-sided; a specific operation (e.g. multiplication) can be performed when a number object enters from one side while the reverse operation (e.g. division) can be performed when a number object enters from the other side.
Number object can pass through number hoops on their own or they can pass through number hoops while being held by the player
When the player passes through a number hoop, all number objects held by the player as ammunition can be affected by the operation associated with the number hoop.

FIG. 8 illustrates diagrammatic representation of a number object 810 passing through a number hoop 710 in one direction. When a number object 810 passes through a number hoop 710, the operation associated with that number hoop 710 is applied to the number object 810. In the depicted embodiment, a number object 810 with value of 2 passes through an ×3 number hoop 710, causing the value to change to a result 820 with a value of 6.

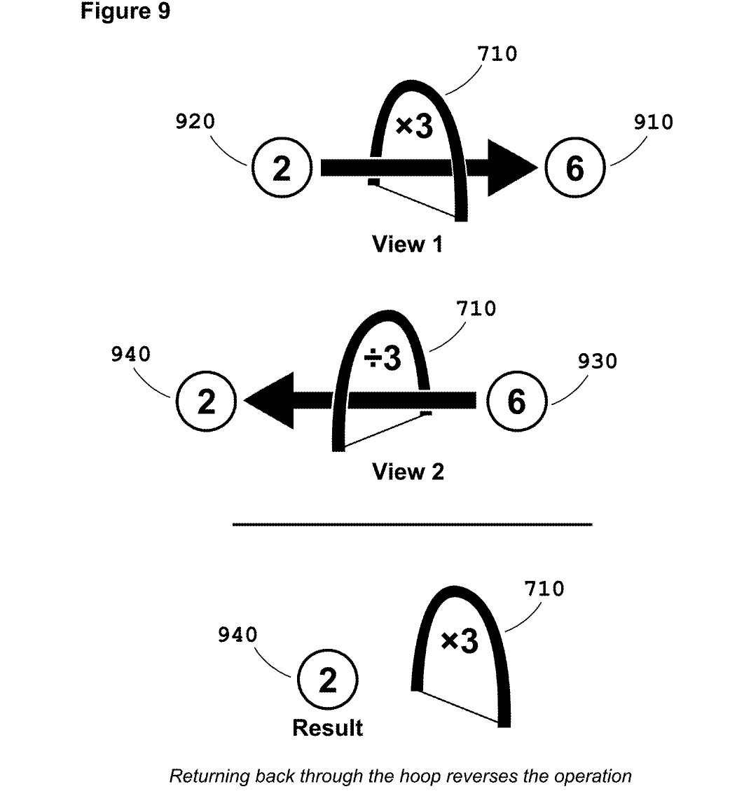

FIG. 9 illustrates a diagrammatic representation of a number object 910, 930 passing through a number hoop 710 from different directions, a “forward” direction and a “backwards” direction. Going “forwards” (entering the number hoop from one side) may perform a first operation, and going “backwards” (entering the number hoop from the other side) may perform an inverse operation. In the depicted embodiment, the number object 910 with value 2 passes through the ×3 number hoop 710 from “forward” direction which multiplies the number object 910 by 3, resulting in number object 920 with value 6.

Another number object 930 with value 6 may pass through the ×3 number hoop 710 from the opposite direction, which divides the number object 930 by 3, and results in number object 940 with value 2.

The terminology “forwards” and “backwards” are not meant to signify anything other than that the number hoop 710 may have two sides and that number objects can enter from two directions—one does not take necessarily precedence before the other in the game world. In some examples, forwards and backwards are interchangeable and the results and explanation would remain the same.

Interactions Between Player and Objects

FIGS. 10-11 illustrate the archetypal interactions between the player avatar and the objects that can be found, collected and used as gadgets or ammunition in the game.

There may be two types of objects that the player can hold and use: (1) gadget objects and (2) number objects. Number objects can be held directly by the player or may be loaded as ammunition in the gadget object held by the player.

FIG. 10 illustrates a symbolic representation of a player avatar 1000. The player's interactions can follow a set of rules. For example:

The player can be represented by an avatar 1000a that can physically interact with objects and the game environment.

The player can move around in three dimensions in the game.

The player can move over a number object or gadget object to pick it up, as illustrated in avatar 1000b and 1000c.

The player can hold one gadget at a time.

When the player is not holding a gadget, the player can hold one number object at a time, as illustrated in avatar 1000c.

FIG. 10 shows the player holding either a gadget object (as in avatar 1000b) or a number object (as in avatar 1000c).

FIG. 11A is a diagrammatic representation of a player avatar 1000 moving over a gadget object 1110 to pick it up. In the depicted embodiment, the player avatar 1000 continues to hold the gadget 1110 after picking it up, as illustrated on avatar 1000b. If a player is currently holding a gadget, any number objects picked up by the player can be loaded into the gadget as ammunition rounds.

FIG. 11B is a diagrammatic representation of a player avatar 1000 moving over a number object 1120 to pick it up. Because the player is not currently holding a gadget 1110 in the depicted embodiment, the player can pick up number objects 1120 directly, as illustrated on avatar 1000c. After picking a number object, the player can hold it or throw it.

Gadgets Overview

Gadget objects 1110 can have properties associated with them, such as:

The player can control a gadget object to affect and change number objects in the game.

The player can pick up a gadget object by physically moving over it in the game.

A gadget object that has been picked up can remain visible next to the player avatar until the end of the level or until it is swapped out.

A visible gadget next to the player avatar can mean that it is currently being held by the player and can be used by the player.

Gadget objects that have already been picked up can be stored in an inventory. The player can access gadgets from the inventory by selecting (e.g., clicking a mouse, touching a screen) the corresponding gadget number. The corresponding gadget number can be selected from player's keyboard or from the graphical user interface. The selected gadget can become visible next to the player avatar.

The player may only wield one gadget at a time.

Some gadgets require number objects as ammunition. These gadgets have ammunition slots and can hold multiple “rounds” of ammunition.

The player can move over a number object to attempt to pick it up as ammunition for the current gadget. If the current gadget has an available ammunition slot, the number will be picked up and added to the gadget as ammunition. If the current gadget does not have any available ammunition slots, the number object will not be picked up.

Some gadgets may not require ammunition.

Ammunition Interactions

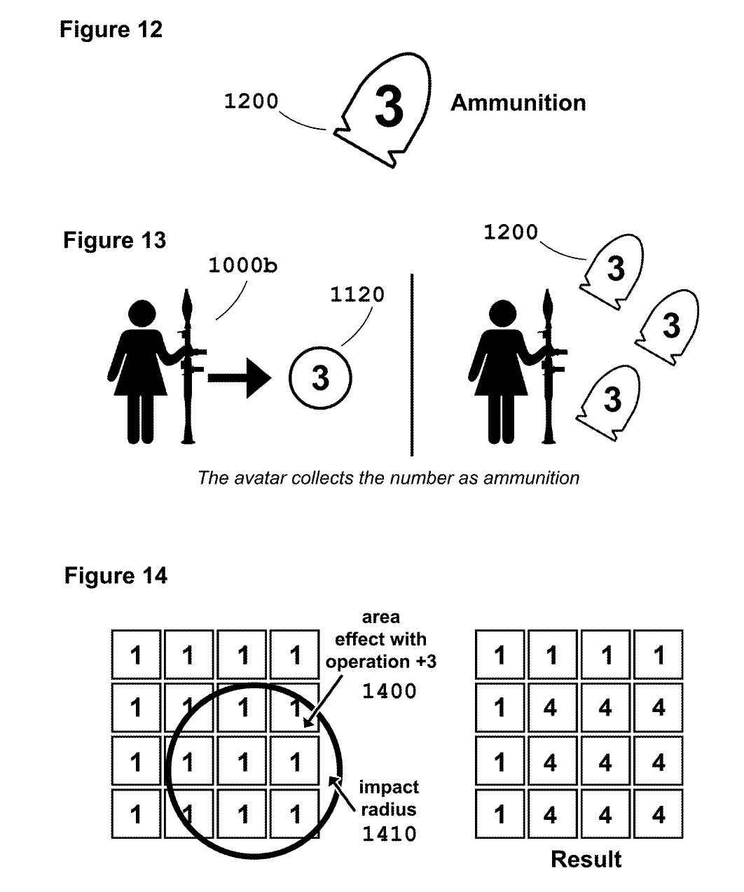

In some embodiments, ammunition is required to use a gadget 1110. FIG. 12 illustrates a symbolic representation of number ammunition object 1200. Ammunition can have the following properties:

Ammunition rounds can be number objects after they have been loaded into a gadget.

Ammunition can disappear after it has been fired and collides with anything in the world.

FIG. 13 illustrates a diagrammatic representation of a player avatar 1000b picking up a number object 1120 as ammunition for a gadget object 1110. In the depicted embodiment, the number object 1120 becomes ammunition rounds 1200 and are loaded into the gadget's available ammunition slots.

In one embodiment of a gadget 1110 requiring ammunition, each number object 1120 that the player picks up becomes one round of ammunition. For example, a gadget 1110 such as a rocket launcher may have 3 available ammunition slots. While holding the rocket launcher, the player may move over number objects 1120, causing them to load into the gadget 1110 until all 3 ammunition slots are filled.

In another embodiment of a gadget 1110 requiring ammunition 1200, each number object 1120 that the player picks up automatically becomes multiple rounds of ammunition. For example, a gadget such as a machine gun may have 10 available ammunition slots. While holding the machine gun, the player may move over a number object to pick it up, causing all 10 ammunition slots to fill up with rounds of the same value as the number object.

In certain embodiments, one round of ammunition impacts only one number object upon collision. For example, a gadget such as a machine gun may hold multiple rounds, but each round can only affect the number object that it hits. To affect multiple number objects, multiple rounds of ammunition must be fired. Similarly, when the player throws a number object without a gadget, the thrown number object will only affect the single number object that it hits.

Other embodiments of gadgets can cause the ammunition to have an area effect on surrounding number objects upon collision. For example, a gadget such as a rocket launcher may hold only 3 rounds and each round must be loaded separately; however, each round of ammunition in this example may have a blast radius of 10 meters, thus enabling this gadget to have a greater impact.

FIG. 14 illustrates one embodiment of how an area effect operation 1400 impacts multiple number objects at the same time. In the depicted embodiment, ammunition with the operation of +3 is fired at a wall of static number objects with the value of 1. The operation is performed on all the number objects within an impact radius 1410, resulting in the new value of 4, while the number objects outside of the impact radius 1410 remain unaffected. The impact radius may vary from gadget to gadget. The player may also be able to earn or buy (with credits) power-ups that increase the impact radius.

Gadget Interactions (No Ammunition)

Some embodiments of gadgets have no ammunition but can perform operations upon number objects.

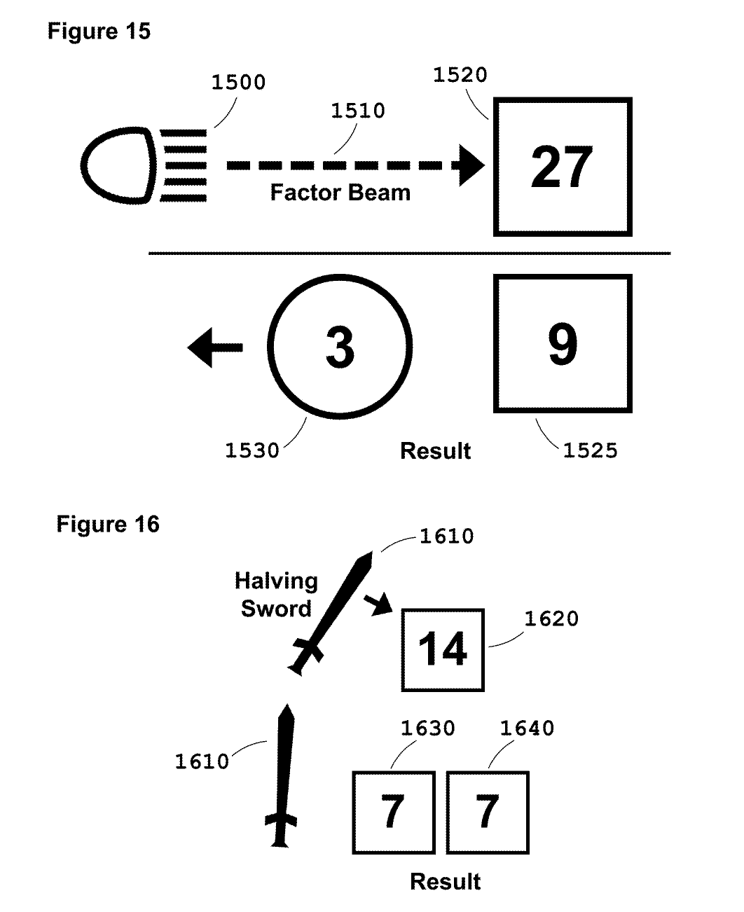

FIG. 15 illustrates a gadget 1500 that breaks a number object into its factors 1525, 1530. In the depicted embodiment, the gadget 1500 projects a beam 1510 onto a number object 1510 that has a factorable value of 27, and pulls a new number object 1530 with the value of 3 (the smallest factor of 27) from the original number object. There is no effect if the beam hits a number object whose value is not factorable.

FIG. 16 illustrates a gadget 1610 that breaks a number object 1620 into fractions. In the depicted embodiment, a sharp gadget 1610 is used to cut a number object 1620 with the value of 14, resulting in two new number objects 1630, 1640 that each has a value of 7 (one-half of the original value). The resulting values may be integers or fractions. In another embodiment of a similar gadget, the cutting action may produce different fractions (e.g. 3 new number objects that each have one-third of the original value). Another embodiment may include a sword-shaped gadget that cuts numbers into halves by physically splitting the number object into two new objects, where each new object has only half the original value or is half the original size.

Animated Number Enemies

FIGS. 17A-B illustrate two embodiments of animated number enemies 1710. An animated number enemy 1710 can be a type of non-playable character (NPC) or artificial intelligence (AI) that can follow a specific set of behavioral rules. In FIG. 17A, the depicted embodiment is an enemy 1710a made up of a single number object, while in FIG. 17B, the depicted embodiment is an enemy 1710b made up of multiple number objects. The number objects associated with an animated number enemy can have the same characteristics as static and dynamic number objects. For example:

They can contain number information (e.g. a value represented as a positive or negative integer, fraction, or percent).

Their value can be displayed as integer text on the object, which can be visible to the player

They can be affected by gadgets

Their values can be changed

They can disappear if their value is set to zero

Some animated number enemies can be transformed into regular number objects through interaction with a gadget, machine, or other transformative module.

Animated number enemies 1710 can differ from static and dynamic number objects in the following ways:

They can have motor behavior and their movements can be controlled by A.I.

They can seek out the player or other targets within the game and move towards those targets.

They can injure or kill the player upon contact.

They cannot be picked up as ammunition (unless they have been transformed into regular number objects).

Some animated number enemies 1710 can also follow a unique set of collision rules. For example:

Animated number enemies will not combine with each other upon collision.

If an animated number enemy, via its own movement, collides with a static or dynamic number object, they will not combine.

If a dynamic number object, via movement driven by the game's physics, collides with an animated number enemy, they will not combine.

If a dynamic number object that is thrown by the player collides with a number object within an animated number enemy, they will combine and the value will change.

If number objects in the form of ammunition fired by the player collide with a number object within an animated number, they will combine and the value will change.

FIG. 18 illustrates an example interaction between a player avatar 1000 and an animated number enemy 1710. In the depicted embodiment, a generic animated number enemy 1710 pursues, then attacks and injures or kills the player 1000.

Specific embodiments of animated number enemies 1710 may have unique characteristics. In one embodiment, the animated number transforms into dynamic number objects if the sign of its value is inverted. For example, if a player fires ammunition with the value of −10 at an animated number with the value of 5, the animated number's value will become negative and cause it to transform into a regular dynamic number object.

In some embodiments, the game world 120 may include AI-controlled “friendly” number creatures that follow similar rules as number objects and number enemies (except the friendly number creatures do not attack the player).

Machinery Overview

Machines are mechanisms by which number objects are generated or transformed in the game world 120. Machines outputs number objects and may or may not receive number objects as inputs. Different examples of machinery are illustrated in FIGS. 19-21.

FIG. 19 illustrates a symbolic representation of a generic machine 1900 within the game world 120 of FIG. 1.

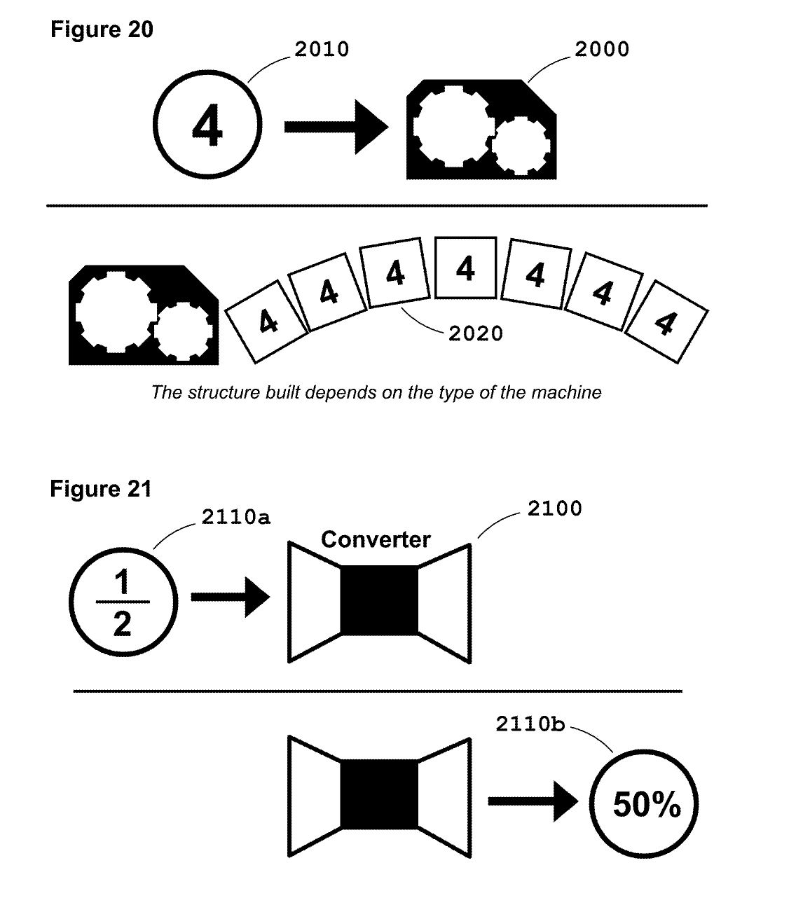

FIG. 20 illustrates a builder machine 2000 that creates structures from number objects. In the depicted embodiment, the builder machine 2000 receives a number object 2010 as input and outputs static number objects 2020 in a bridge-shaped formation that a player avatar may walk across. Different types of builder machines 2000 may output different structures constructed of number objects.

FIG. 21 illustrates a conversion machine 2100 that changes a form, but not a value, of a number object 2110 (e.g. inputs a fraction 2110a and outputs a percentage 2110b).

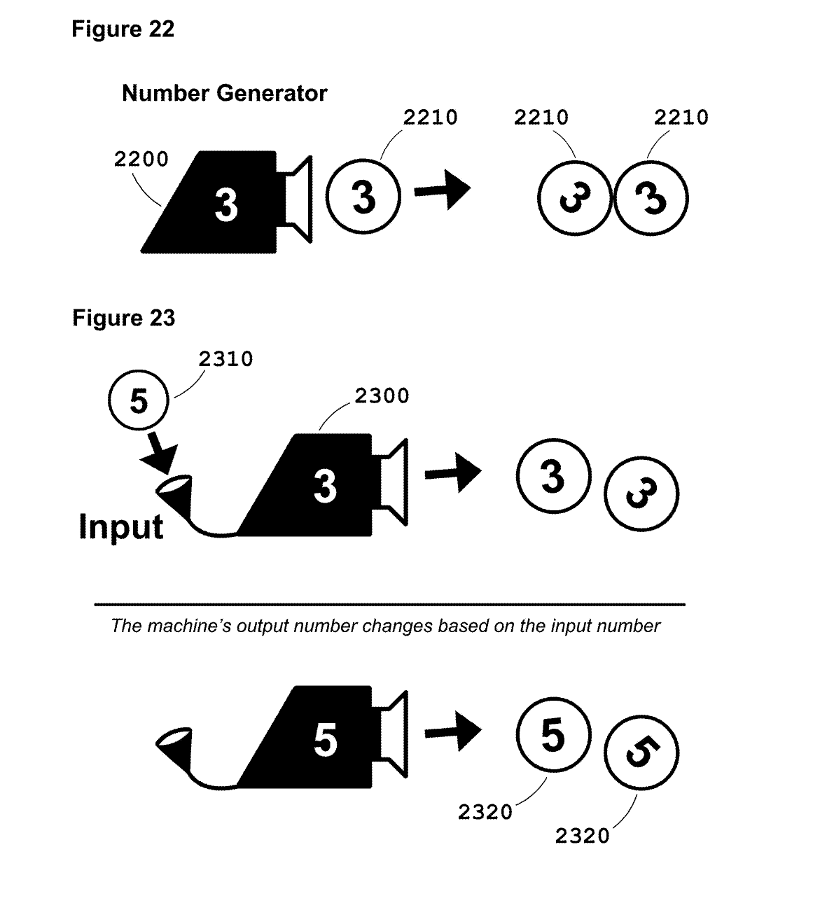

FIG. 22 illustrates a number generator 2200 that outputs number objects 2210. The number generator 220 may provide a continuous output of number objects 2210. In some embodiments, the number generator 220 may provide an output of number objects 2210 that is limited, automatic or triggered by the player or by an event.

Other types of machine transformations are contemplated. A machine may transform numbers into any type of in-game structure. For example, a building machine can receive dynamic objects (e.g., numbers) to build a skyscraper. In some implementations, the machine can receive other types of machines combined with further machines and/or numbers to create yet other machines. For example, a machine can create a rod and a small disc. The rod and small disc can be placed back into the machine and they machine can combine the rod and small disc to create a shovel. The shovel can be combined with a number 4 to multiply the size of the shovel by 4 times. In other implementations, the number 4 multiplies the number of shovels by 4, such that feeding one shovel with the number 4 yields 4 shovels.

In some implementations, the numbers received by a machine can change during the creation of a new set of objects. For example, when building a bridge, a machine can require a number 4. Half way through the build, the machine can stop requiring a 4 and start requiring a 5. Once the machine receives one or more 5 objects, the machine can complete the remaining portion of the bridge.

Changing Outputs

FIG. 23 illustrates a modification applied to a number generation machine 2300. In the depicted embodiment, a new number object 2310 is placed into the number generator machine, causing the machine to output number objects 2320 bearing a new value based on the input number 2310.

FIG. 24 illustrates a modification applied to a number hoop 710 (as described in FIGS. 7-9). The number hoop 710 may be modified by inputting a new number 2410. In the depicted embodiment, a new number object 2410 (e.g., number 5) is placed into a number hoop 710 to modify the mathematical operation that it performs on the dynamic number objects passing through by 5. For example, before the number 5 was placed into the number hoop 710, passing a number 2 through the number hoop 710 would multiply the 2×3 and yield a number 6. After the number 5 is placed into the number hoop 710, passing a number 2 through the number hoop 710 would multiply the 2×5 and yield a number 10, as illustrated.

Credits Mechanics

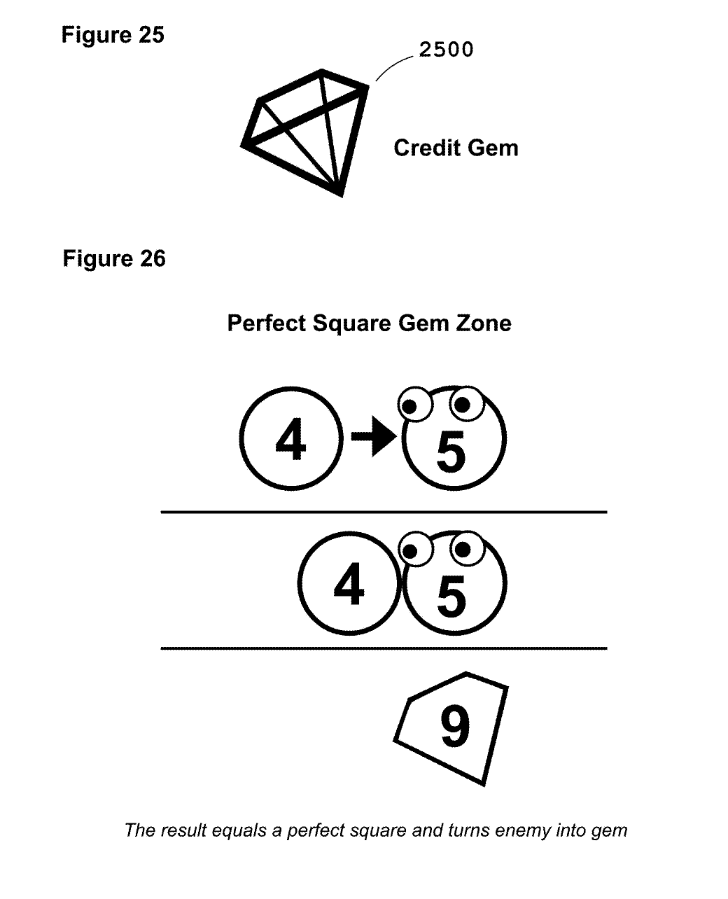

Credits 2500 may appear in the game in the form of crystals or gems. Credits 2500 can be a form of currency within the game and/or the platform and can be used to purchase items such as power-ups, special tools, or other modules to be used in the game or the level-builder. Item purchase can take place through an online marketplace that can be in-game or outside of the game. FIG. 25 is a diagrammatic representation of a credit gem 2500.

Credits can be earned in the game in a variety of ways, including but not limited to A) collecting crystals/gems dropped by enemies that match specific number values/properties, B) taking consecutive actions that match a pre-defined pattern, (e.g., the player “gets the right answer” without making any mistakes a bunch of times in a row) or C) depositing number objects into a credit factory.

FIG. 26 illustrates a gem zone in which enemies could be transformed into collectable credits called gems. A “gem zone” may be a puzzle module (or an entire level) within which enemies whose number(s) match specific values/properties will turn into gems. In the depicted embodiment, the gem zone rule specifies that all enemies whose numbers are transformed into perfect squares (e.g. 4, 9, 16, 25) will become gems.

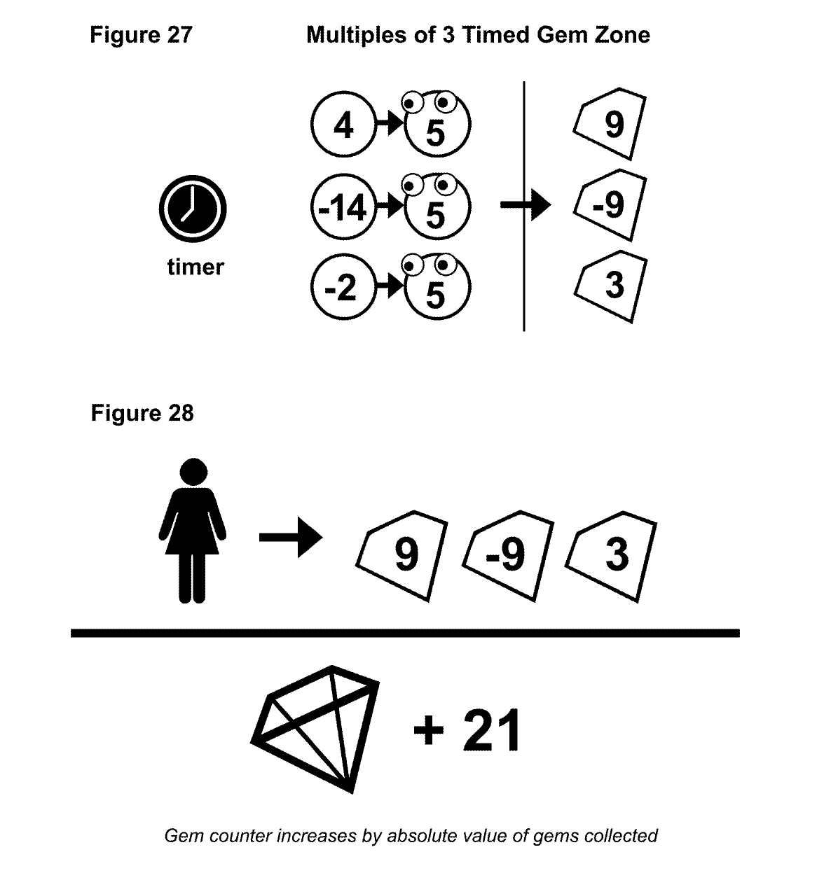

FIG. 27 illustrates a gem zone that runs on a timer. In the depicted embodiment, enemies that are transformed into multiples of 3 before the timer runs out will become gems. The timer may be set off in a variety of ways, including but not limited to the player's entry into the gem zone, the transformation of the first number enemy, or other triggers that cause the timer to start. In another embodiment of a timed gem zone, enemies may appear in groups, and may respawn (e.g., recreate after its death, destruction or removal) unless the player destroys or transforms all of the enemies before the timer runs out. In another embodiment of the timed gem zone, the timer may stop early if the player performs the wrong action (e.g. transformed an enemy into a value inconsistent with the gem zone's rules) and the player will have to start the level or the gem zone area over again.

FIG. 28 illustrates a diagrammatic representation of the credit gem collection process. In the depicted embodiment, the player moves over the credit gems to pick them up. In some implementations, a credit gem is worth one unit of value. In other implementations, the total value of the credit gems collected is displayed in a gem counter. The value of each gem can be the absolute value of the number attached to the gem. For example, a number enemy with the value of negative-9 at the time of transformation will create a gem with the value of 9, and will increase the gem counter by 9 when picked up by the player.

Credits can be used in the in-game store to purchase items such as gadgets, building structures or materials, number generators, dynamic number sets, or other items and/or modules.

Credit Factory

A credit factory can be a machine that takes numbers of specifically defined values and earns credits for the player who deposited them. Credit factories may only accept numbers that match a specific mathematical value, property, or pattern. For example, Credit Factory A will only earn the player credits if the numbers deposited are prime. The quantity of credits (“c”) earned by the player will be a function of the number (“n”) deposited by that player, i.e. if the player deposits a 5 into Credit Factory A which uses the formula F(A)=f(n)=n̂n+n=c, the player would earn 5̂5+5 credits. In another example, Credit Factory B only accepts numbers that are a factor of 100, and earns the player F(B)=f(n)=2n̂3=c credits for each successful deposit.

Each type of credit factory follows a different set of rules. Players may buy (with credits) different types of credit factories, or trade with other players, such as through an online marketplace that can be in-game or outside of the game.

In an example, a credit factory can follow 4 sequential rules for determining how credits are earned:
Rule 1: Deposit Type
Example 1: Credit Factory A accepts prime numbers only 24 hours
Rule 2: Growth Formula
Example 2: Credit Factory A follows the function F(A)=f(n)=n̂n+n over a period of 24 hours
Rule 3: Max Capacity at end of Growth Period
Example 3: Credit Factory A ceases to earn credits after reaching the end of the growth period
Rule 4: Withdrawal (similar to harvesting)
Example 4: Gem credits from Credit Factory A can only be withdrawn at the end of 24 hours after deposit has “matured”; withdrawal requires player action

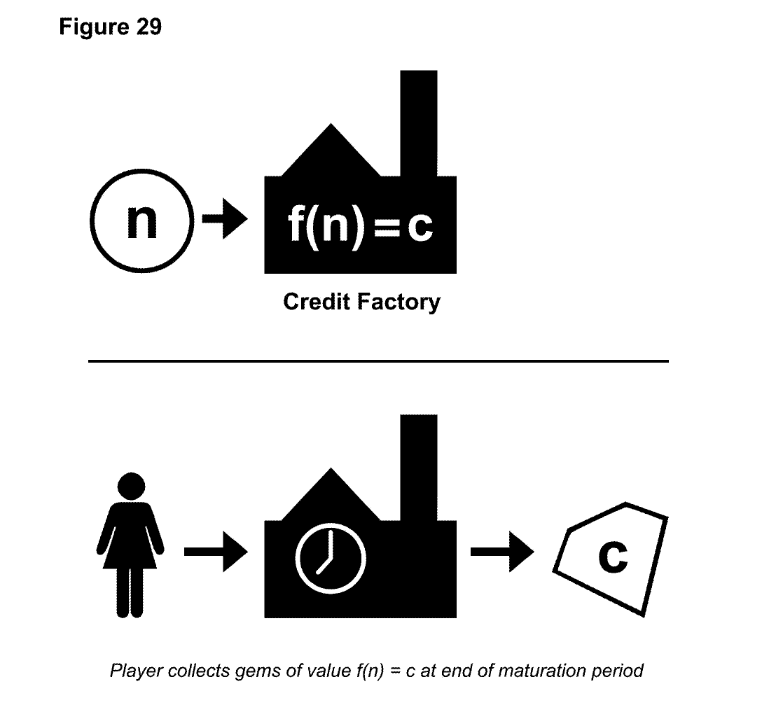

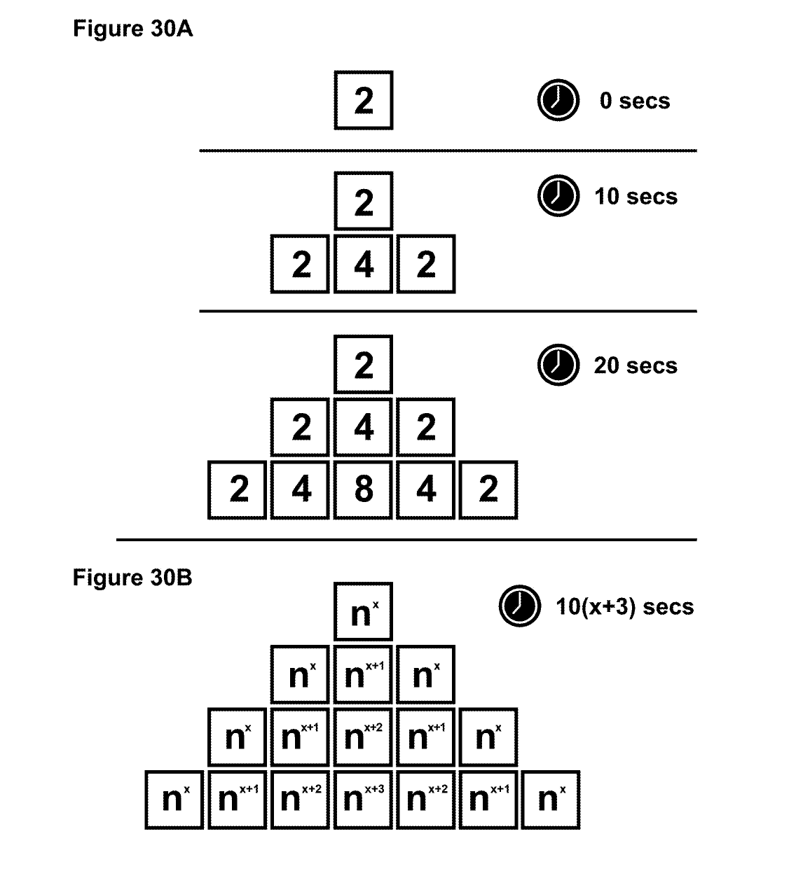

FIG. 29 illustrates a credit factory 2900 that may transform number objects into credit gems according to a growth formula. In the depicted embodiment, a number object of value “n” is deposited into the credit factory 2900. The number factory will accept the deposit if “n” matches Rule 1. The number object “n” is transformed into credits “c” according to the growth function f(n)=c defined in Rule 2. During the maturation period, the player will not be able to collect the credits. At the end of the timed growth period defined in Rule 3, the player must interact with the credit factory (e.g. by touching it) to collect the credit gems of value “c” according to Rule 4.

In some implementations, the credit factory 2900 can output an unknown output, some of which may be undesirable to a user. A credit factory 2900 can require a specific input number, which can be easy or difficult to obtain. For example, a credit factory 2900 can require the fraction: 217/34499, which is more difficult to obtain than an integer input. In implementations, the credit factory 2900 can output a number of gems (e.g., one credit gem) that may not reflect the difficulty or amount of time the user spent to create the number. In other implementations, the credit factory can reward a user for her time to collect the fraction by outputting a large number of credit gems.

Growth Mechanic Structures

In some implementations, the credit factory 2900 can implement a growth mechanic structure. Growth mechanic structures can be made of dynamic or static number objects that continue to produce additional numbers over time according to an algorithm. For example, a growth mechanic structure may produce one random prime number whose value is less than 1,000 every 10 seconds; in another embodiment, a growth mechanic structure may produce one random prime number whose value is more than 1000 and less than 10,000 every 5 minutes. Growth mechanic structures can be bought with credits or traded with other players.

FIGS. 30A-B illustrate growth mechanic structures that may produce new number objects. A “Number Fountain” is one type of structure made of static number objects whose composition, size, and shape may be determined by its growth mechanic. For example, Number Fountain A may produce a power of 2 every 10 seconds, with each successive number produced growing by a multiple of 2, so that the sequence of numbers generated would be 2, 4, 8, 16, 32, and so on. FIG. 30A depicts a diagrammatic embodiment Number Fountain A. FIG. 30B depicts a more generic embodiment of a similar number fountain which has produced an exponential pattern of static number objects after 10(x+3) seconds, where “x” denotes the initial power.

Other types of growth mechanic structures may include bridges, pyramids, towers, fortresses, etc. whose sizes, shapes, and compositions of number objects are determined by their unique growth algorithms. In some implementations of the growth mechanic structure (e.g. bridges), the structure's growth can be triggered by the player's action (e.g. inputting a mathematical operation); the player can walk upon the structure to traverse to a different part of the level. In other implementations, the growth mechanic structures can be used to fortify the player's defense against A.I. enemies or other players (e.g. fortress structures in multi-player mode); the player can utilize the structure's growth algorithm to grow obstacles or barricades made of numbers that are difficult for the opponents to break through.

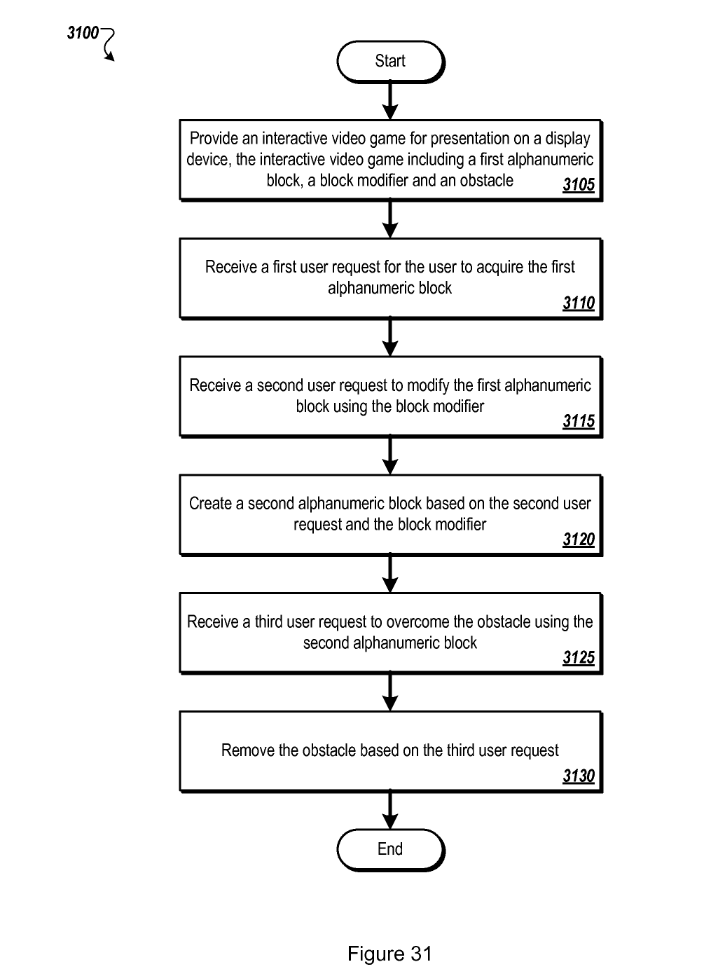

FIG. 31 is a flow diagram illustrating a method 3100 for providing an educational game platform, in accordance with some embodiments of the present disclosure. In one embodiment, method 3100 may be performed by a server 106 or a client 102, as illustrated in FIG. 1.

Referring to FIG. 31, the method 3100 begins at block 3105 where processing logic provides an interactive video game for presentation on a display device. The interactive video game includes a first alphanumeric block, a block modifier and an obstacle. The first alphanumeric block may be a graphical representation of one of: an integer, a fraction, a real number, or an imaginary number. The block modifier may be an arithmetic operation, such as an addition, a subtraction, a multiplication, or a division. The first alphanumeric block may be a positive integer and the second alphanumeric block may be a negative integer. In some embodiments, a sum of the first alphanumeric block and the second alphanumeric block is zero. The obstacle may be any mechanism that prevents the user from advancing within the interactive video game, such as a wall, a trap, etc.

At block 3110, the processing logic receives a first user request for the user to acquire the first alphanumeric block. At block 3115, the processing logic receives a second user request to modify the first alphanumeric block using the block modifier. The second user request may include an instruction to perform an arithmetic operation on the first alphanumeric block.

At block 3120, the processing logic creates a second alphanumeric block based on the second user request and the block modifier. At block 3125, the processing logic receives a third user request to overcome the obstacle using the second alphanumeric block. At block 3130, the processing logic removes the obstacle based on the third user request.

In some embodiments, the processing logic is associated with a server, and the first user request, the second user request and the third user request are received from a client device.

In some embodiments, receiving the third user request to overcome the obstacle using the second alphanumeric block includes providing a graphical representation of a gadget to propel the second alphanumeric block, receiving a fourth user request to use the gadget to propel the second alphanumeric block toward the obstacle, and providing an animation of the second alphanumeric block contacting the obstacle.

In some embodiments, the first alphanumeric block is a graphical representation of a letter of an alphabet. The block modifier may be associated with an operation to combine the first alphanumeric block with a third alphanumeric block. The second user request to modify the first alphanumeric block using the block modifier may include an instruction to combine the first alphanumeric block with the third alphanumeric block. Creating the second alphanumeric block based on the second user request and the block modifier may include combining the first alphanumeric block with a third alphanumeric block to form the second alphanumeric block.

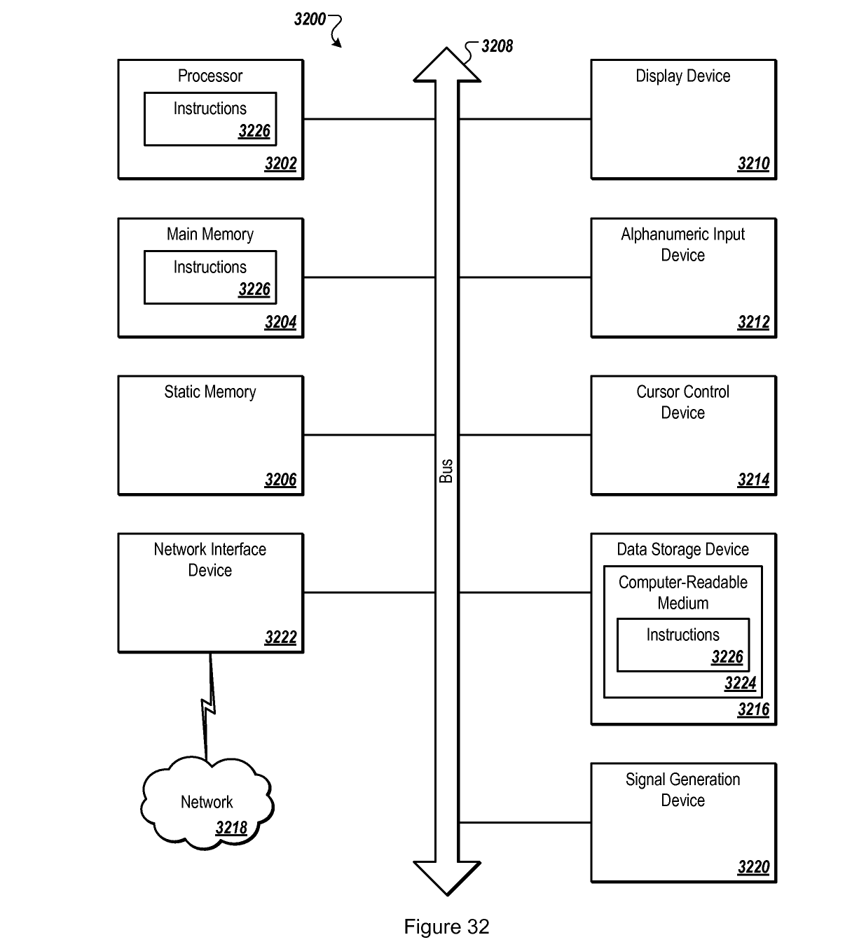

FIG. 32 is a schematic diagram that shows an example of a machine in the form of a computer system 3200 that may perform one or more of the operations described herein. The computer system 3200 executes one or more sets of instructions 3226 that cause the machine to perform any one or more of the methodologies discussed herein. The machine may operate in the capacity of a server or a client machine in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions 3226 to perform any one or more of the methodologies discussed herein.

The computer system 3200 includes a processor 3202, a main memory 3204 (e.g., read-only memory (ROM), flash memory, dynamic random access memory (DRAM) such as synchronous DRAM (SDRAM) or Rambus DRAM (RDRAM), etc.), a static memory 3206 (e.g., flash memory, static random access memory (SRAM), etc.), and a data storage device 3216, which communicate with each other via a bus 3208.

The processor 3202 represents one or more general-purpose processing devices such as a microprocessor, central processing unit, or the like. More particularly, the processor 3202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 3202 may also be one or more special-purpose processing devices such as an application specific integrated circuit (ASIC), a field programmable gate array (FPGA), a digital signal processor (DSP), network processor, or the like. The processor 3202 is configured to execute instructions of the gaming platform for performing the operations and steps discussed herein.

The computer system 3200 may further include a network interface device 3222 that provides communication with other machines over a network 3218, such as a local area network (LAN), an intranet, an extranet, or the Internet. The computer system 3200 also may include a display device 3210 (e.g., a liquid crystal display (LCD) or a cathode ray tube (CRT)), an alphanumeric input device 3212 (e.g., a keyboard), a cursor control device 3214 (e.g., a mouse), and a signal generation device 3220 (e.g., a speaker).

The data storage device 3216 may include a computer-readable storage medium 3224 on which is stored the sets of instructions 3226 of the gaming platform embodying any one or more of the methodologies or functions described herein. The sets of instructions 3226 of the gaming platform may also reside, completely or at least partially, within the main memory 3204 and/or within the processor 3202 during execution thereof by the computer system 3200, the main memory 3204 and the processor 3202 also constituting computer-readable storage media. The sets of instructions 3226 may further be transmitted or received over the network 3218 via the network interface device 3222.

While the example of the computer-readable storage medium 3224 is shown as a single medium, the term “computer-readable storage medium” can include a single medium or multiple media (e.g., a centralized or distributed database, and/or associated caches and servers) that store the sets of instructions 3226. The term “computer-readable storage medium” can include any medium that is capable of storing, encoding or carrying a set of instructions for execution by the machine and that cause the machine to perform any one or more of the methodologies of the present disclosure. The term “computer-readable storage medium” can include, but not be limited to, solid-state memories, optical media, and magnetic media.

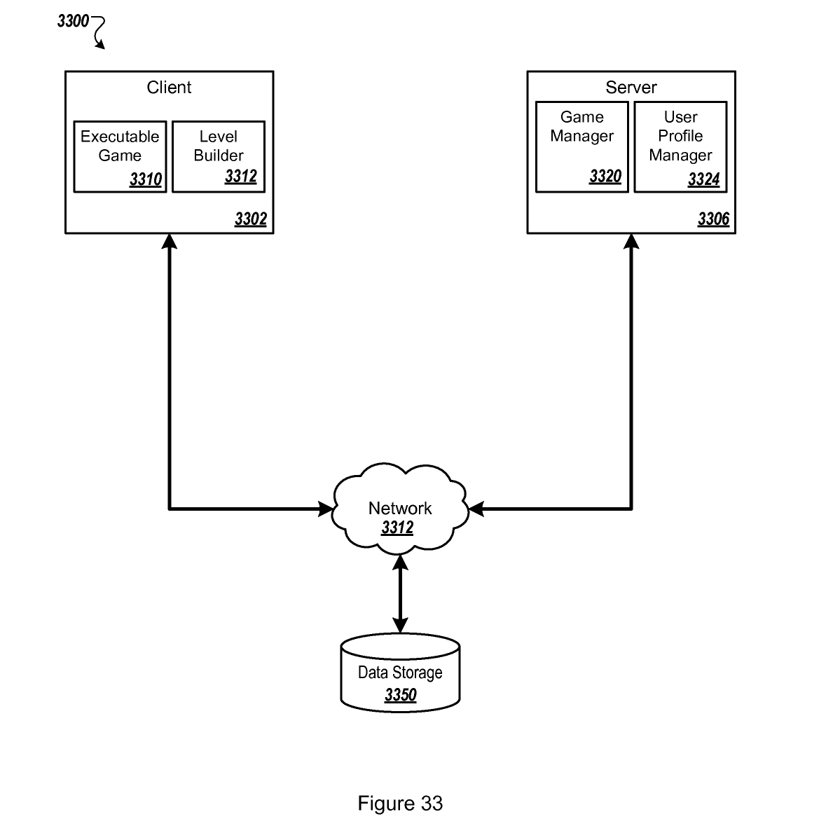

FIG. 33 illustrates example system 3300 architecture in which implementations can operate. The system architecture 3300 can include any number of clients 3302, one or more server machines 3306, and one or more data stores 3350. Each of the client(s) 3302, server(s) 3306 and the data storage 3350 may be coupled to each other, such as over a network 3312. Network 3312 may be a public network (e.g., the Internet), a private network (e.g., a local area network (LAN) or wide area network (WAN)), or a combination thereof.

The client 3302 can be a portable computing device, such as, and not limited to, cellular telephones, personal computer (PC), personal digital assistants (PDAs), portable media players, netbooks, laptop computers, an electronic book reader or a tablet computer (e.g., that includes a book reader application), and the like. The client can run an operating system (OS) that manages hardware and software of the client.

Server 3306 can be a rack mount server, a router computer, a personal computer, a portable digital assistant, a laptop computer, a desktop computer, a media center, a tablet, a stationary machine, or any other computing device capable of performing modifications to videos.

The data store 3350 can store items relating to educational gaming, such as, and not limited to, user account information, levels, modules, components, puzzles, decorative modules, toolbox, user data, computer code, and any other data or information pertaining to playing, building, creating and modifying educational games, etc. These items can be received from any source, including components of the client 3302, server 3306, another client, a remote storage, etc. The data store 3350 can be a persistent storage that is capable of storing data. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items. The data store can be internal to the client or external to the client and accessible by the client via a network. The data store can be internal to the server or external to the server and accessible by the server via a network. As will be appreciated by those skilled in the art, in some implementations data store may be a network-attached file server or a cloud-based file server, while in other implementations data store might be some other type of persistent storage such as an object-oriented database, a relational database, and so forth.

The client 3302 can present a graphical user interface to the user via a display device. The GUI can present a graphical representation of game components that comprise a game. GUI can be a user interface to allow a user to interact with a client and a game running on the client or server. GUI can include one or more user interface tools. As the term is used herein, a user interface tool refers to any single graphical instrument or combination of graphics controls that permit a user to input information to a computer system. Common conventional user interface tools include visual output for one or more buttons, text boxes, scroll bars, pictures, spin dials, list boxes, search boxes, select options, etc.

The client 3302 can include an executable game 3310 that it can receive from a game source, such as the server 3306 or the data storage 3350. The executable game 3310 can run entirely using the client 3302 without any interaction with another client or server. In another implementation, the executable game 3310 can run on the client 3302 while in communication with other devices, such as other clients or one or more servers 3306, or a combination of servers and clients. For example, a server can execute a game manager 3320 that interfaces with the client 3302. In implementations, the server hosts a massively multiplayer online game (MMOG) with a server component (e.g., the game manager) and a client component (e.g., the executable game). The client and server components can share the processing of various instructions and can communicate to handle this processing efficiently.

In implementations, the client 3302 includes a level builder 3312 that permits a user to create levels, as described herein. Levels that the user creates can be uploaded to the server 3306, to the data storage 3350, or both. The server 3306 can track the user generated levels and can permit them to be downloaded and/or played by other users. In implementations, users can be compensated for creating levels. In some implementations, users can also pay (e.g., using real currency, fiat money, digital credits, tokens, in-game currency, gems, etc.) to access certain features provided by the server 3306. Such features can include access to more levels, new gadgets, new level builder tools, etc.

In implementations, the server 3306 includes a user profile manager 3324 that can be used to identify and track users. To obtain the executable game, for example, users can create an account using the user profile manager 3324. The user profile manager 3324 can keep track of a user's gaming activities, such as levels played, beat, created, etc. The user can edit the information included in the user profile manager 3324 and can remove any personally identifiable information.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, it is appreciated that throughout the description, discussions utilizing terms such as “identifying”, “providing”, “enabling”, “finding”, “selecting” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. The terms “first,” “second,” “third,” “fourth,” etc. as used herein are meant as labels to distinguish among different elements and may not necessarily have an ordinal meaning according to their numerical designation.

The terms “first,” “second,” “third,” “fourth,” etc. as used herein are meant as labels to distinguish among different elements and may not necessarily have an ordinal meaning according to their numerical designation.

It is to be understood that the above description is intended to be illustrative, and not restrictive. Other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
providing an interactive video game for presentation on a display device, the interactive video game comprising a first alphanumeric block, a block modifier and an obstacle;
receiving a first user request for the user to acquire the first alphanumeric block;
receiving a second user request to modify the first alphanumeric block using the block modifier;
creating, by a processing device, a second alphanumeric block based on the second user request and the block modifier;
receiving a third user request to overcome the obstacle using the second alphanumeric block; and
removing the obstacle based on the third user request.

2. The method of claim 1, wherein the first alphanumeric block is a graphical representation of one of: an integer, a fraction, a real number, or an imaginary number.

3. The method of claim 1, wherein the block modifier is an arithmetic operation comprising an addition, a subtraction, a multiplication, or a division.

4. The method of claim 33, wherein the second user request comprises an instruction to perform the arithmetic operation on the first alphanumeric block.

5. The method of claim 1, wherein the first alphanumeric block is a positive integer and wherein the second alphanumeric block is a negative integer.

6. The method of claim 5, wherein a sum of the first alphanumeric block and the second alphanumeric block is zero.

7. The method of claim 1, wherein the obstacle is to prevent the user from advancing within the interactive video game.

8. The method of claim 1, wherein receiving the third user request to overcome the obstacle using the second alphanumeric block comprises:
providing a graphical representation of a gadget to propel the second alphanumeric block;
receiving a fourth user request to use the gadget to propel the second alphanumeric block toward the obstacle; and
providing an animation of the second alphanumeric block contacting the obstacle.

9. The method of claim 1, wherein the processing device is associated with a server, and wherein the first user request, the second user request and the third user request are received from a client device.

10. The method of claim 1, wherein the first alphanumeric block is a graphical representation of a letter of an alphabet, wherein the block modifier is associated with an operation to combine the first alphanumeric block with a third alphanumeric block, wherein the second user request to modify the first alphanumeric block using the block modifier comprises an instruction to combine the first alphanumeric block with the third alphanumeric block, wherein creating the second alphanumeric block based on the second user request and the block modifier comprises combining the first alphanumeric block with a third alphanumeric block to form the second alphanumeric block.

11. The method of claim 910, wherein the second alphanumeric block and the obstacle are a same value.

12. A system comprising:
a display device;
a memory; and
a processing device coupled to the display device and to the memory, the processing device to:
present, via a graphical user interface (GUI) in the display device, an interactive video game, the interactive video game comprising a first alphanumeric block, a block modifier and an obstacle;
receive, via the GUI, a first user request for the user to acquire the first alphanumeric block;
receive, via the GUI, a second user request to modify the first alphanumeric block using the block modifier;
create a second alphanumeric block based on the second user request and the block modifier;
receive, via the GUI, a third user request to overcome the obstacle using the second alphanumeric block; and
remove the obstacle based on the third user request.

13. The system of claim 12, wherein the first alphanumeric block is a graphical representation of one of: an integer, a fraction, a real number, or an imaginary number.

14. The system of claim 12, wherein the block modifier is an arithmetic operation comprising an addition, a subtraction, a multiplication, or a division.

15. The system of claim 12, wherein the first alphanumeric block is a positive integer and wherein the second alphanumeric block is a negative integer.

16. The system of claim 12, wherein the obstacle is to prevent the user from advancing within the interactive video game.

17. The system of claim 12, wherein when receiving a third user request to overcome the obstacle using the second alphanumeric block, the processing device is to:
provide, via the GUI, a graphical representation of a gadget to propel the second alphanumeric block;
receive, via the GUI, a fourth user request to use the gadget to propel the second alphanumeric block toward the obstacle; and
provide, via the GUI, an animation of the second alphanumeric block contacting the obstacle.

18. A non-transitory computer readable storage medium comprising instructions that, when executed by a processing device, cause the processing device to perform operations comprising:
providing an interactive video game for presentation on a display device, the interactive video game comprising a first alphanumeric block, a block modifier and an obstacle;
receiving a first user request for the user to acquire the first alphanumeric block;
receiving a second user request to modify the first alphanumeric block using the block modifier;
creating, by the processing device, a second alphanumeric block based on the second user request and the block modifier;
receiving a third user request to overcome the obstacle using the second alphanumeric block; and
removing the obstacle based on the third user request.

19. The non-transitory computer readable storage medium of claim 18, wherein the first alphanumeric block is a graphical representation of one of: an integer, a fraction, a real number, or an imaginary number.

20. The non-transitory computer readable storage medium of claim 18, wherein the obstacle is to prevent the user from advancing within the interactive video game.
